(19) United States
(12) Patent Application Publication
(10) Pub. No.: US 2021/0185999 A1
(43) Pub. Date: Jun. 24, 2021

(54) LIGHTING DEVICE FOR REDUCING BIRD STRIKE AND METHOD FOR REDUCING BIRD STRIKE IN WIND FARM

(71) Applicant: Institute of Zoology, Guangdong Academy of Science, Guangdong (CN)

(72) Inventors: Xuebing Zhao, Guangdong (CN); Fasheng Zou, Guangdong (CN); Min Zhang, Guangdong (CN); Xianli Che, Guangdong (CN)

(73) Assignee: Institute of Zoology, Guangdong Academy of Sciences, Guangdong (CN)

(21) Appl. No.: 17/123,361

(22) Filed: Dec. 16, 2020

(30) Foreign Application Priority Data
Dec. 19, 2019 (CN) 201911320891.8

(51) Int. Cl. A01M 29/10; F03D 80/30

(52) U.S. Cl. CPC A01M 29/10; F03D 80/30

(57) ABSTRACT

The present disclosure provides a lighting device for reducing bird strikes and a method for reducing bird strikes in a wind farm. The lighting device includes an illuminator, and the illuminator emits red light with a wavelength of 620-750 mm. In the present disclosure, the red light with a wavelength of 620-750 mm is used as a light source of the lighting device to reduce the attraction to birds; therefore, strikes of birds on the position of the lighting device can be reduced, overcoming a longstanding technical prejudice that people have generally accepted that blue light is used as a light source for reducing bird strikes because the red light is easy to attract birds, which are too sensitive to the blue light to be attracted easily.

### TECHNICAL FIELD

The present disclosure relates to the technical field of light driving birds, and in particular to a lighting device for reducing bird strikes and a method for reducing bird strikes in a wind farm.

### BACKGROUND

At present, the light pollution is becoming more and more serious on the earth, and colorful artificial light sources have a great impact on the ecosystem. As far as birds are concerned, there have been many incidents of birds striking artificial light sources around the world.

In the wild, it has long been discovered that some artificial light sources can cause migratory birds to lose direction during night migration and fly toward the light source (Avery et al., 1976; Rowan, 1925). With the development of human society, artificial light sources are more and more widely used. The increasing number of artificial light sources has seriously affected the migration of birds (La Sorte et al., 2017; Cabreracruz et al., 2018). Light can interfere with the choice of midway habitats of migratory birds (Mclaren et al., 2018), causing birds to reduce flight speed thereof and gather under the attraction of light sources (Van Doren et al., 2017). Bird strikes caused by artificial light sources have been continuously reported. Objectives of strikes include lighthouses illuminated at night, ships, oil rigs, airports, and tall buildings (Avery and Cassel, 1976; Crawford and Engstrom, 2001; Jones and Francis, 2003; Flemming and Kasper, 2011). The accidents of migratory birds striking light sources during the annual migration season have caused a large number of migratory bird deaths (Core et al., 2002; Longcore et al., 2008). The North American communication towers kill 4-5 million birds annually, most of which are new tropical species that migrate at night (Shire and Winegrad, 2000).

Fall is a peak of phototactic strikes of birds. In addition, weather conditions will further affect the phototaxis of birds. In addition to these natural conditions that people cannot change, the properties of the light source per se further affect the phototaxis of birds at night, and the light wavelength may be an important factor affecting the phototactic flight of birds. Migratory birds relying on cryptochrome proteins for geomagnetic orientation and the behavior of migratory birds striking artificial light sources at night cannot be separated from light stimulation, and are related to the light wavelength. Did the migratory birds strike the artificial light sources during the night migration because the normal magnetic orientation of the migratory birds was interfered by the light source? At present, experimental studies have shown that red light can interfere with the bird's geomagnetic orientation (Wiltschko et al., 1993); Poot et al. (2008) believed that red light was easy to attract migratory birds to strike, and that it might be because disordered geomagnetic orientation of birds under the stimulation of the red light caused the birds to strike the artificial light sources. Because the cryptochrome proteins used by birds for geomagnetic orientation are only activated under ultraviolet light and blue light, but under red light and completely without light, cryptochrome proteins are basically not activated (Nieβner et al., 2011; Nieβner et al., 2014), so the magnetic orientation ability of birds under the irradiation of long wavelength light (red light) is disturbed and birds cannot be oriented normally (Wiltschko et al., 1993; Wiltschko et al., 1995; Wiltschko et al., 2004; Wiltschko et al., 2014). Therefore, based on the current research, it is generally believed that the red light is easy to attract migratory birds to strike, and birds are sensitive to blue light and not easy to be attracted. The blue light can be used as a light source to reduce bird strikes. For example, China Patent No. CN105557679A discloses an “illuminating bird repelling device and a bird repelling method using the device”. In this solution, the blue light is used to repelling birds. The solution also considers that the blue light is not attractive to birds, thereby achieving a bird repelling effect.

In addition, wind power generation is the world's fastest growing energy production technology and has become a considerable industry. Wind power is considered to be a clean new energy production method; however, wind farms will also have a greater impact on birds, and especially, offshore wind farms and mountain wind farms located near migratory bird migration channels often cause bird strikes. The bird monitoring data for some wind farms near migratory bird migration channels have shown that the main reason for the bird strikes is that the light of wind farm booster stations will attract migratory birds migrating at night, causing the birds to strike bright buildings. It has been found that most migratory birds migrate at night and have phototaxis during the night migration, especially on the foggy night. Due to the production safety and life requirements of the wind farm booster station, it is difficult to completely eliminate outdoor lighting, and thus it is necessary to design a lighting device for reducing bird strikes.

### SUMMARY

A first objective of the present disclosure is to provide a lighting device for reducing bird strikes, in order to solve the technical problem that the existing luminous light sources are easy to attract birds to strike, and to overcome a longstanding technical prejudice that people have generally accepted that blue light is used as a light source for reducing bird strikes because red light is easy to attract birds, which are sensitive to the blue light.

A second objective of the present disclosure is to provide a method for reducing bird strikes in a wind farm to reduce the strikes of birds in the wind farm.

To achieve the first objective of the present disclosure, the present disclosure provides:

a lighting device for reducing bird strikes includes an illuminator, where the illuminator emits red light with a wavelength of 620-750 mm.

Further, the lighting device for reducing bird strikes may include a power regulator for regulating the working power of the illuminator.

Further, the illuminator may be an LED lamp.

To achieve the first and second objectives of the present disclosure, the present disclosure provides:

a method for reducing bird strikes in a wind farm includes:
disposing floodlights at four corners of a wind farm booster station and at a place in which outdoor equipment needs illumination, where the floodlights are inclined downward.

The floodlights emit red light with a wavelength of 620-750 mm during operation.

Further, the method for reducing bird strikes in a wind farm may include: adjusting the lighting of the floodlights at 10-200 W according to different weather conditions and lighting requirements.

Further, the floodlights may be principally used for night lighting during the migration season of migratory birds, i.e., the floodlights may need to illuminate at 100-150 W at clear nights and 30-50 W at foggy nights.

Further, the migration season of migratory birds may be from the beginning of March to the end of May, and from late August to the end of November.

Further, the floodlights may be LED floodlights.

Compared with the prior art, the present disclosure has the following beneficial effects:

In the present disclosure, the red light with a wavelength of 620-750 mm is used as a light source of the lighting device to reduce the attraction to birds; therefore, strikes of birds on the position of the lighting device can be reduced, overcoming a longstanding technical prejudice that people have generally accepted that blue light is used as a light source for reducing bird strikes because the red light is easy to attract birds, which are too sensitive to the blue light to be attracted easily.

### BRIEF DESCRIPTION OF THE DRAWINGS

FIG. 1 shows the number of birds caught by light sources of different colors at Jinshan Pass;

FIG. 2 shows the number of birds caught by light sources of different colors in Zuomeiguo.

### DETAILED DESCRIPTION

The content of the present disclosure will be further described in detail below with reference to the drawings and specific examples.

### Example 1

The example provided a lighting device for reducing bird strikes, including an LED illuminator, where the LED illuminator emitted red light with a wavelength of 620-750 mm.

Preferably, the lighting device for reducing bird strikes further included a power regulator for regulating the working power of the LED illuminator to adapt to different weather and climate to reduce the attraction to birds.

To verify the effectiveness of the lighting device for reducing bird strikes provided by this example, the inventors carried out the following research experiments:

The research sites are located at Zuomeiguo (N23° 37′21″, E103° 30′24″, altitude 2,334 m) and Jinshan Pass (N23° 56′40″, E101° 29′50″, altitude 2,467 m) in Zhenyuan County, Yunnan Province, China; both locations are important gathering places for migratory birds at night. These two gathering places are respectively located at the ridge passes of the Dahei Mountain and Ailao Mountain Range from northwest to southeast, and the distance between the two sites is about 200 km. During the migration of migratory birds to the south in fall, the birds need to cross the mountain range. Due to the obstruction of the mountain range, the migratory birds gather and migrate along the valley on the east slope of the mountain range, and finally cross over from some of the lower passes of the mountain range. Due to the influence of the southwest monsoon in fall, the surroundings of the gathering places are often meshed in the dense fog. It is found that in this weather condition, many migratory birds at night will strike buildings or automobile light sources near the passes. Taking advantage of the phototaxis of migratory birds, the local forestry department uses lights to trap migratory birds in the migratory gathering places of migratory birds every fall to carry out bird banding. Over the past 20 years, the number of bird bandings at night in Yunnan Province has exceeded 140,000.

The research work was carried out simultaneously at two gathering points. Each hillside facing the direction of bird migration was selected to support a mist net (aperture 36 mm, length 12 m, height 2.6 m, 5 pockets), and a light source was placed 0.5 m in front of the net to attract migratory birds. Four-color (red, yellow, green and blue) LED light sources were selected, among which red, blue and green lights were monochromatic, and yellow light was compound, which were also the colors of light sources used for trapping birds at bird banding stations. The four-color light sources had a power of 50 W, and the relevant light source data are shown in Table 1. The light sources were regularly turned on at 20 o'clock every day, and each light source continuously irradiated for one hour and then another color of the light source was changed until 0 o'clock in the morning, during which bird migration at night also peaked. In order to reduce the error in the number of migratory birds in the early and late period of the nightly survey period, the time sequence of turning on the light sources of different colors was rotated in turn every night. The types and numbers of birds trapped by light sources of different colors, along with the wind direction and fog at that time, were recorded. The birds caught were released after bird banding the next morning.

TABLE 1
Experimental light source data

| | Wave | Color | Power |
|---|---|---|---|
| Color | length (nm) | temperature (k) | (W) |
| Red | 620 | | 100 |
| Yellow | | 2,000 | 100 |
| Green | 520 | | 100 |
| Blue | 455 | | 100 |

When analyzing the data, nonparametric 1-sample K-S test was first performed on each group of data to check whether each group of data was normally distributed. After testing, the data of this survey did not have a normal distribution, so nonparametric Friedman test was used. A generalized linear model was used for analysis in order to determine whether the factors causing a difference in bird catches were different weather conditions, sequence of use of different lights, or light source colors. The data were statistically analyzed using SPSS version 22 software, and the results are as follows:

1. Bird Catches Obtained from Light Sources Having Different Wavelengths

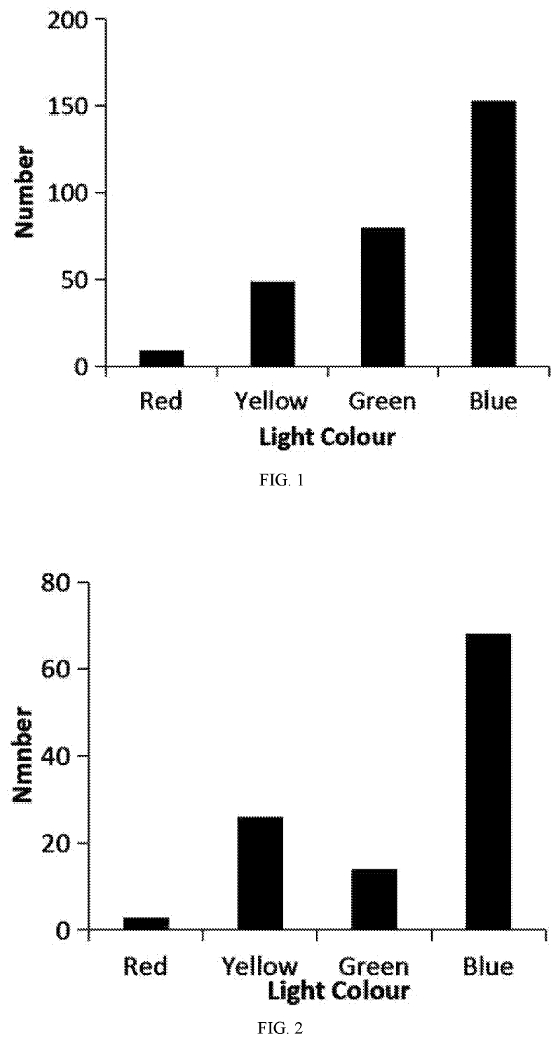

Birds were trapped by lighting at Jinshan Pass during the migration period in fall. Two-year data showed that blue light sources were the most attractive to migratory birds at night, and a total of 294 birds of 35 species were caught; while the red light caught the least, i.e., 32 birds of 8 species; there was a significant difference in the number of birds trapped by light sources with different wavelengths (Friedman χ²=24.261, n=41, df=3, P=0.000). The result of Zuomeiguo was similar to that of the Jinshan Pass. The blue light attracted the most birds and caught 68 birds of 23 species, while the red light caught the least bird species, i.e., there were 3 birds of 3 species; there was also a significant difference in the number of birds trapped by light sources with different wavelengths (Friedman χ²=14.969, n=27, df=3, P=0.002). In general, with the increase of the wavelength of the three monochromatic lights, the number of trapped birds decreases in sequence. The attraction of yellow light as a compound light is between blue and red light, as shown in FIGS. 1 and 2.

At night, a total of 705 birds of 51 species were trapped by light sources at Jinshan Pass and in Zuomeiguo. The largest species was Lanius cristatus, with a catch of 363 birds. In addition to passerine birds, more cuckoos and herons were also caught. From the perspective of the attraction of light sources of different colors to birds, most bird species appeared to be easily attracted by the blue light and were not sensitive to the red light (Table 2). There was an extremely significant difference in the degree of attraction of these light sources of different colors to birds at Jinshan Pass (Friedman χ²=39.608, n=51, df=3, P=0.000) and in Zuomeiguo (Friedman χ²=32.973, n=32, df=3, P=0.000). It can be seen that the characteristic of being easily attracted by the blue light source but not attracted by the red light source is a common phenomenon among various migratory birds at night.

### 2. Composition of Bird Species

At night, a total of 705 birds of 51 species were trapped by light sources at Jinshan Pass and in Zuomeiguo. The largest species was Lanius cristatus, with a catch of 363 birds. In addition to passerine birds, more cuckoos and herons were also caught. From the perspective of the attraction of light sources of different colors to birds, most bird species appeared to be easily attracted by the blue light and were not sensitive to the red light (Table 2). There was an extremely significant difference in the degree of attraction of these light sources of different colors to birds at Jinshan Pass (Friedman χ²=39.608, n=51, df=3, P=0.000) and in Zuomeiguo (Friedman χ²=32.973, n=32, df=3, P=0.000). It can be seen that the characteristic of being easily attracted by the blue light source is a common phenomenon among various migratory birds at night.

TABLE 2
Bird species and numbers trapped by light sources of different colors

| JSYK | | | | | | | | | ZMG | | | | |
|---|---|---|---|---|---|---|---|---|---|---|---|---|---|
| | 2017 | | | | 2018 | | | | | 2017 | | | |
| | R | Y | G | B | R | Y | G | B | | R | Y | G | B |
| Lanius cristatus | 9 | 33 | 52 | 110 | 12 | 15 | 28 | 71 | Lanius cristatus | 0 | 10 | 1 | 22 |
| Cuculus poliocephalus | 0 | 1 | 2 | 0 | 0 | 2 | 6 | 15 | Ardeola bacchus | 1 | 5 | 4 | 8 |
| Acrocephalus aedon | 0 | 1 | 3 | 3 | 3 | 2 | 10 | 3 | Dicrurus hottentottus | 1 | 2 | 0 | 6 |
| Nycticorax nycticorax | 0 | 0 | 0 | 4 | 2 | 1 | 1 | 12 | Ixobrychus cinnamomeus | 0 | 0 | 1 | 5 |
| Treron sphenura | 0 | 1 | 3 | 6 | 0 | 2 | 0 | 6 | Urosphena squameiceps | 0 | 2 | 1 | 2 |
| Luscinia calliope | 0 | 0 | 1 | 1 | 0 | 6 | 7 | 0 | Cuculus sparverioides | 0 | 1 | 0 | 4 |
| Porzana fusca | 0 | 1 | 6 | 3 | 0 | 0 | 2 | 1 | Nycticorax nycticorax | 0 | 0 | 1 | 3 |
| Luscinia cyane | 0 | 1 | 0 | 1 | 0 | 4 | 3 | 3 | Cuculus canorus | 0 | 0 | 0 | 3 |
| Otus scops | 0 | 0 | 0 | 3 | 2 | 1 | 5 | 0 | Luscinia cyane | 1 | 0 | 1 | 1 |
| Halcyon pileata | 0 | 3 | 3 | 4 | 1 | 0 | 0 | 0 | Ficedula albicilla | 0 | 0 | 1 | 1 |
| Cuculus saturatus | 0 | 1 | 0 | 0 | 0 | 3 | 4 | 3 | Halcyon pileata | 0 | 0 | 1 | 1 |
| Ficedula albicilla | 0 | 0 | 1 | 0 | 0 | 1 | 4 | 4 | Rallina eurizonoides | 0 | 0 | 0 | 1 |
| Vanellus cinereus | 0 | 0 | 0 | 0 | 0 | 1 | 4 | 5 | Locustella thoracica | 0 | 1 | 0 | 0 |
| Dicrurus hottentottus | 0 | 0 | 0 | 2 | 0 | 0 | 3 | 2 | Muscicapa dauurica | 0 | 0 | 0 | 1 |
| Oriolus chinensis | 0 | 1 | 1 | 4 | 1 | 0 | 0 | 0 | Cyornis hainanus | 0 | 0 | 0 | 1 |
| Ardeola bacchus | 0 | 2 | 0 | 1 | 0 | 0 | 0 | 3 | Gorsachius magnificus | 0 | 0 | 1 | 0 |
| Cuculus sparverioides | 0 | 0 | 1 | 1 | 0 | 1 | 2 | 1 | Gallinula chloropus | 0 | 1 | 0 | 0 |
| Cuculus canorus | 0 | 0 | 0 | 1 | 0 | 0 | 2 | 2 | Luscinia calliope | 0 | 0 | 0 | 1 |
| Streptopelia tranquebarica | 0 | 1 | 1 | 0 | 0 | 1 | 0 | 2 | Porzana fusca | 0 | 1 | 0 | 0 |
| Locustella certhiola | 0 | 1 | 0 | 0 | 0 | 0 | 2 | 1 | Acrocephalus aedon | 0 | 0 | 1 | 0 |
| Clamator coromandus | 0 | 1 | 1 | 0 | 0 | 0 | 0 | 1 | Ixobrychus sinensis | 0 | 1 | 0 | 0 |
| Lanius tephronotus | 0 | 0 | 0 | 0 | 0 | 2 | 1 | 0 | Turnix tanki | 0 | 0 | 0 | 1 |
| Saxicola ferrea | 0 | 0 | 1 | 1 | 0 | 0 | 0 | 1 | Emberiza aureola | 0 | 1 | 0 | 0 |
| Cyornis banyumas | 0 | 0 | 0 | 0 | 0 | 2 | 1 | 0 | Bubulcus ibis | 0 | 0 | 0 | 1 |
| Turnix tanki | 0 | 1 | 1 | 0 | 0 | 0 | 0 | 0 | Alcedo atthis | 0 | 1 | 0 | 0 |
| Sturnus malabaricus | 0 | 0 | 0 | 0 | 0 | 0 | 2 | 0 | Cyornis banyumas | 0 | 0 | 0 | 1 |
| Cinclidium frontale | 0 | 0 | 1 | 1 | 0 | 0 | 0 | 0 | Surniculus lugubris | 0 | 0 | 0 | 1 |
| Hodgsonius phoenicuroides | 0 | 0 | 1 | 0 | 0 | 0 | 0 | 0 | Oriolus tenuirostris | 0 | 0 | 0 | 1 |
| Amaurornis phoenicurus | 0 | 0 | 0 | 1 | 0 | 0 | 0 | 0 | Locustella certhiola | 0 | 0 | 1 | 0 |
| Muscicapa dauurica | 0 | 0 | 0 | 0 | 0 | 0 | 0 | 1 | Bradypterus | 0 | 0 | 0 | 1 |
| | | | | | | | | | tacsanowskius | | | | |
| Chrysococcyx maculatus | 0 | 0 | 0 | 1 | 0 | 0 | 0 | 0 | Ixobrychus eurhythmus | 0 | 0 | 0 | 1 |
| Bradypterus seebohmi | 0 | 0 | 0 | 0 | 0 | 0 | 0 | 1 | | | | | |
| Acrocephalus concinens | 0 | 0 | 0 | 0 | 0 | 1 | 0 | 0 | | | | | |
| Dicrurus macrocercus | 0 | 0 | 0 | 1 | 0 | 0 | 0 | 0 | | | | | |
| Gallinula chloropus | 0 | 0 | 0 | 0 | 0 | 1 | 0 | 0 | | | | | |
| Phylloscopus inornatus | 0 | 0 | 0 | 0 | 0 | 0 | 1 | 0 | | | | | |
| Phylloscopus proregulus | 0 | 0 | 0 | 1 | 0 | 0 | 0 | 0 | | | | | |
| Psittacula finschii | 0 | 0 | 0 | 1 | 0 | 0 | 0 | 0 | | | | | |
| Chalcophaps indica | 0 | 0 | 0 | 0 | 1 | 0 | 0 | 0 | | | | | |
| Scolopax rusticola | 0 | 0 | 0 | 0 | 0 | 0 | 0 | 1 | | | | | |
| Anthus hodgsoni | 0 | 0 | 0 | 0 | 0 | 0 | 1 | 0 | | | | | |
| Cuculus micropterus | 0 | 0 | 0 | 0 | 0 | 1 | 0 | 0 | | | | | |
| Porzana pusilia | 0 | 0 | 0 | 0 | 0 | 0 | 0 | 1 | | | | | |
| Delichon dasypus | 0 | 0 | 1 | 0 | 0 | 0 | 0 | 0 | | | | | |
| Ixobrychus eurhythmus | 0 | 0 | 0 | 1 | 0 | 0 | 0 | 0 | | | | | |
| Chrysococcyx | 0 | 0 | 0 | 0 | 1 | 0 | 0 | 0 | | | | | |
| xanthorhynchus | | | | | | | | | | | | | |
| Myophonus caeruleus | 0 | 0 | 0 | 1 | 0 | 0 | 0 | 0 | | | | | |
| Porzana bicolor | 0 | 0 | 0 | 0 | 0 | 0 | 0 | 1 | | | | | |
| Hierococcyx fugax | 0 | 0 | 0 | 0 | 0 | 1 | 0 | 0 | | | | | |
| Ficedula hyperythra | 0 | 0 | 0 | 0 | 0 | 1 | 0 | 0 | | | | | |
| Uncertain flycatcher | 0 | 0 | 0 | 0 | 0 | 1 | 0 | 0 | | | | | |

It can be seen from the above experimental results that the red light source can attract less migratory birds at night, while the blue light source will attract the largest number of migratory birds; use of red wavelength light source has a significant effect on reducing bird strikes on the light source. Therefore, the present disclosure overcomes a technical prejudice that it is traditionally generally accepted that the blue light is used as a light source for reducing bird strikes because the red light is easy to attract birds, which are too sensitive to the blue light to be attracted easily. In this way, in some high-risk areas where it is difficult to cancel the lights, and in the case that the weather conditions are beyond the control of people, use of the red light that is less sensitive to birds is a convenient, economical and effective measure to reduce bird strikes, and in particular, use of flickering light sources can further reduce the chance of bird strikes.

### Example 2

This example provided a method for reducing bird strikes in a wind farm. This method was mainly achieved by disposing floodlights at four corners of a wind farm booster station and at a place in which outdoor equipment needs illumination.

Specifically, the floodlight was an LED floodlight, including LED beads, a regulator, a housing, and a post. The beads were red LED illuminators with a wavelength of 620-750 nm. The regulator regulated the power of the floodlight. According to different weather conditions and lighting requirements, the floodlights were illuminated at 10-200 W. Sealant tapes were used at the opening and closing of the housing to ensure the waterproof requirements for outdoor use. A knob for adjusting the light power was provided on the housing. The height of the post was between 2 and 2.5 m; the column was hollow, and the inside was a wire connecting the floodlight and power supply; and the power supply used AC power.

By adopting the method for reducing bird strikes in a wind farm provided by the present disclosure, that is, by disposing the floodlights at four corners of the wind farm booster station and at a place in which outdoor equipment needs illumination; after using the beads as a red LED illuminator with a wavelength of 620-750 m, migratory birds were basically not attracted by the light emitted by the red LED illuminator during migration; thus, the occurrence of bird strikes on lighting devices, wind farm booster stations and buildings was reduced effectively, and normal bird migration was not further influenced.

Preferably, the floodlights were inclined downward by 60 degrees to avoid excessive divergence of light upwards to further reduce the attraction to birds.

In addition, the floodlights were mainly used for night lighting during the migration seasons of migratory birds (from early March to end of May, and from late August to end of November), and could illuminate at 100-150 W at clear nights. At foggy nights, the floodlights need to reduce the lighting power and use red lighting at 30-50 W to further reduce the attraction of migratory birds at night.

The above examples are only for explaining the technical concept and features of the present disclosure, and the objective thereof is to enable those of ordinary skill in the art to understand the content of the present disclosure and implement therefrom, but not to limit the protection scope of the present disclosure. Any equivalent changes or modifications made according to the essence of the present disclosure shall fall within the protection scope of the present disclosure.

What is claimed is:

1. A lighting device for reducing bird strikes, comprising an illuminator, wherein the illuminator emits red light with a wavelength of 620-750 mm.

2. The lighting device for reducing bird strikes according to claim 1, further comprising a power regulator for regulating the working power of the illuminator.

3. The lighting device for reducing bird strikes according to claim 1, wherein the illuminator is an LED lamp.

4. The lighting device for reducing bird strikes according to claim 2, wherein the illuminator is an LED lamp.

5. The lighting device for reducing bird strikes according to claim 3, wherein the LED lamp works in a flickering manner.

6. The lighting device for reducing bird strikes according to claim 4, wherein the LED lamp works in a flickering manner.

7. A method for reducing bird strikes in a wind farm, comprising:
disposing floodlights at four corners of a wind farm booster station and at a place in which outdoor equipment needs illumination, wherein the floodlights are inclined downward;
the floodlights emit red light with a wavelength of 620-750 mm during operation.

8. The method for reducing bird strikes in a wind farm according to claim 7, further comprising: adjusting the lighting of the floodlights at 10-200 W according to different weather conditions and lighting requirements.

9. The method for reducing bird strikes in a wind farm according to claim 8, wherein the floodlights are principally used for night lighting during the migration season of migratory birds, i.e., the floodlights need to illuminate at 100-150 W at clear nights and 30-50 W at foggy nights.

10. The method for reducing bird strikes in a wind farm according to claim 9, wherein the migration season of migratory birds is from the beginning of March to the end of May, and from late August to the end of November.

11. The method for reducing bird strikes in a wind farm according to claim 8, wherein the floodlights are each inclined downward by 60 degrees.

12. The method for reducing bird strikes in a wind farm according to claim 7, wherein the floodlights are LED floodlights.

13. The method for reducing bird strikes in a wind farm according to claim 8, wherein the floodlights are LED floodlights.

14. The method for reducing bird strikes in a wind farm according to claim 9, wherein the floodlights are LED floodlights.

15. The method for reducing bird strikes in a wind farm according to claim 10, wherein the floodlights are LED floodlights.

16. The method for reducing bird strikes in a wind farm according to claim 11, wherein the floodlights are LED floodlights.
